(19) United States
(12) Patent Application Publication
(10) Pub. No.: US 2026/0343238 A1
(43) Pub. Date: Oct. 29, 2026

(54) SYSTEMS AND METHODS FOR SECURING DEVICES COMMUNICATING VIA IOT NETWORKS

(71) Applicant: Aeris Communications Inc., Santa Clara, CA (US)

(72) Inventors: Subramanian Balakrishnan, Cupertino, CA (US); Narendra Sharma, Sunnyvale, CA (US); David Hu, Sunnyvale, CA (US); Ethan Hoewisch, San Jose, CA (US)

(21) Appl. No.: 19/551,020

(22) Filed: Feb. 26, 2026

Related U.S. Application Data
(60) Provisional application No. 63/765,408, filed on Feb. 28, 2025.

(51) Int. Cl. H04W 12/37; H04W 12/71; H04W 24/08; H04W 84/18

(52) U.S. Cl. CPC H04W 12/37; H04W 12/71; H04W 24/08; H04W 84/18

(57) ABSTRACT

Disclosed example methods for monitoring IoT devices communicating via a communication network involve: collecting data traffic associated with one or more IoT devices assigned to a subscription profile; identifying anomalous communication behavior by individual ones of the IoT devices based on the data traffic and based on a mapping of a unique identifier of each of the IoT devices to an IP address; defining enforcement rules for at least one of an individual one of the IoT devices or a group of the IoT devices; assigning the enforcement rules to the IoT devices or a group of the IoT devices based on the mapping of the unique identifier of each of the IoT devices to the IP address; and controlling data traffic of the IoT devices through the communication network based on the enforcement rules assigned to the IoT devices.

### FIELD OF THE DISCLOSURE

The present disclosure relates to Internet of Things (IoT) communications networks and, more particularly, to systems and methods for securing devices communicating via IoT networks.

### BACKGROUND

IoT, also known as machine to machine (M2M), network communications involve technologies enabling devices to communicate with other devices, often having similar capabilities, and servers. In a basic example of an IoT deployment, a device having limited capabilities and/or logic (e.g., a sensor, meter, etc.) is deployed at a location to capture measurable event data (e.g., temperature, pressure, quantity, location, etc.). IoT devices may be also embedded into more complex devices or systems, such as an automobile. The IoT device is connected through a communications network to a remote computer or server having an application layer of specific software. The data received from the device is converted to relevant information associated with the measured event data through the application. The data is often used for analysis for a purpose, either individually to the device or in aggregate with multiple similar devices. In many cases a device, when activated, may trigger and communicate the events it is intended for so that those communicated events will then be acted upon by other machines, applications, and/or users on the network.

Limitations and disadvantages of conventional approaches will become apparent to one of skill in the art, through comparison of such approaches with some aspects of the present method and system set forth in the remainder of this disclosure with reference to the drawings.

### SUMMARY

Systems and methods for securing devices communicating via IoT networks are disclosed, substantially as illustrated by and described in connection with at least one of the figures, and as set forth more completely in the claims.

### BRIEF DESCRIPTION OF THE DRAWINGS

These and/or other aspects will become apparent and more readily appreciated from the following description of the exemplary embodiments, taken in conjunction with the accompanying drawings.

FIG. 1 is a schematic diagram of an example system to secure IoT devices communicating via a cellular IoT network, in accordance with aspects of this disclosure.

FIG. 2 illustrates an example user interface that may be provided by the system of FIG. 1 to access data traffic transmitted from and/or transmitted to an example IoT device connected to the cellular IoT network.

FIG. 3 illustrates another example user interface that may be provided by the system of FIG. 1 to access data traffic transmitted from and/or transmitted to multiple IoT devices connected to the cellular IoT network.

FIGS. 4A-4C illustrate example user interfaces that may be provided by the system of FIG. 1 to group a set of IoT devices for traffic monitoring and/or policy enforcement based on specified criteria.

FIG. 5A illustrates an example user interface that may be provided by the system of FIG. 1 to summarize anomalous traffic for groups of devices.

FIG. 5B illustrates another example user interface that may be provided by the system of FIG. 1 to summarize anomalous traffic for all IoT devices for a subscriber profile.

FIGS. 6A-6C illustrate example user interfaces that may be provided by the system of FIG. 1 to create an enforcement policy for one or more IoT devices connected to the cellular IoT network.

FIG. 7 is a block diagram of an example computing system that may be used to implement components of the system of FIG. 1.

The figures are not necessarily to scale. Where appropriate, similar or identical reference numbers are used to refer to similar or identical components.

### DETAILED DESCRIPTION

M2M environments often involve systems of networks, wired and wireless, that are to connect IoT devices to public and private networks. Example IoT devices include personal appliances, sensors, automobiles, and any other device which can be provided with the necessary equipment, such as Subscriber Identification Modules (SIMs), to communicate with the IoT network. In IoT networks, devices may be stationary or mobile, and may be connected via wired and/or wireless access protocols, such as through WiFi network protocols and/or 3GPP Mobile network protocols. IoT devices may have seasonal and/or elastic connectivity needs (e.g., agricultural business needs, store and forward capabilities, etc.). In busy IoT communication networks, there is often an ‘always on’ device being used such as a general packet radio services (GPRS) or internet gateway. However, conventional IoT communication infrastructure remains most suited to the communication needs and patterns of device having similar abilities, characteristically, for communicating with other systems and device on the same network.

Cellular IoT (“Internet of Things”) , also referred to as machine-to-machine (M2M) connected devices are very difficult to protect from external hackers or hidden backdoors due to the wide diversity of devices, device resource constraints, lack of standardization, and limited update mechanisms. Additionally, due to their frequent design and functionality limitations, IoT devices may appear to a user or owner of such device or group of devices to be operating or functioning as intended, but could be communicating in an unintended, undesirable manner or to an unintended or undesirable destination. These factors, combined with weak authentication, network exposure, and supply chain vulnerabilities, result in a potentially wide attack surface for IoT deployments. Disclosed systems and methods provide a comprehensive security solution, implemented at the network level, to provide visibility into cellular IoT security threats and mitigate threats. Disclosed example systems and methods proactively prevent, block, and/or mitigate security incidents, providing substantial risk reduction and regulatory compliance for cellular-based IoT deployments.

Zero Trust is an approach to network and device security that tightly controls which connections a device can make, and monitors devices frequently or continuously so that the system knows what the devices are doing at all times and can detect and react when device behavior becomes malicious. Conventional cellular IoT deployments are unable to effectively implement Zero Trust controls, due to onerous technical challenges involved in implementation. For example, conventional cellular IoT deployments are incapable of knowing the activity of cellular IoT devices without installing an agent on the device. Agents can be undesirable due to the processing, storage, power, and/or communication overhead involved in executing the agent on the target device, as well as the cost involved in deploying compatible security agents to the devices. Many cellular IoT devices are designed with little to no available processing power beyond core functions, making the addition of a security agent detrimental to the business purpose of the cellular IoT device. Conventionally, device security is provided by using authentication and authorization, or through use of firewalls. However, conventional implementations may still leave IoT devices vulnerable to attacks from their own networks, or leave services vulnerable to attacks from their own devices, which may affect the enterprise's business and cost them millions of dollars overnight.

In contrast with conventional cellular IoT network solutions, disclosed systems and methods identify risks and threats associated with individual cellular IoT devices and/or groups of cellular IoT devices at the network level. Disclosed example systems and methods are network-based and cellular or connectivity carrier-agnostic, can be rapidly enabled, and can be activated on existing cellular IoT deployments without installing agents on IoT devices, because such example systems and methods are implemented using network-level resources. Disclosed systems and methods respond to identified anomalous behavior to reduce exposure and/or attack surface to identified cellular IoT devices, as well as proactively protect assets from compromised or misbehaving cellular IoT devices using cellular network traffic-based policies. Disclosed example systems and methods can help a deployment operator identify when devices are not communicating or behaving as expected, which allows further investigation and resolution.

Some disclosed example systems and methods collect detailed behavior of IoT devices connected to the cellular IoT network, and the traffic generated by the devices, including general traffic volume statistics, suspicious traffic volume statistics, and anomalous behavior events. The traffic statistics and/or events may be organized by endpoints, DNS FQDNs, IMSI, and/or groupings for consumption by relevant network users and administrators, or enterprise customers deploying an IoT service or solution. In disclosed examples, network administrators or enterprise customers deploying IoT solutions can quickly and easily discover non-compliant devices based on the behavior shown by the device and/or identify undesired or unauthorized activity. Based on the collected data and analysis, cellular IoT network operators, enterprise customers, and/or their respective security teams can gain real-time visibility into the attack surface of the cellular IoT devices and network, as well as take steps to reduce the attack surface. Disclosed examples collect information about the IP flows for customer devices, and make the collected information available to the customer in near real time.

In conventional IoT communication networks, customers do not have access to the device communications data for devices owned by the customer, and are unable to access information about data traffic. Accordingly, customers of conventional IoT communication networks and deployments rely on requesting usage data or traffic flow data from cellular operators, which can be time consuming and expensive.

In conventional networks, a device's data usage at the aggregate packet session level is provided to the customer, such as session start/stop times and total data transferred. While this cellular session data provides customers the quantity of data consumed by each device, it provides no visibility into the actual data flows, such as the destination IP or hostname of the device data.

If customer device connections are limited to a single remote server endpoint (or their own server endpoints), then it is possible for them to extract the data flow details (i.e. usage) from devices to the server endpoints. However, scenarios exist in which the device traffic completely bypasses the customer network, such as when multiple end user applications are deployed on the gateway device which communicate with different server endpoints, a gateway device is used as a hot spot and communicates to a range of server endpoints, or a rogue device initiates communication with server endpoints outside the approved list.

In all the above cases, enterprise customers do not have access to the device data for the devices in their network, and are unable to collect the data flow details. However, since the device traffic in the above cases flows through the service provider, such as a mobile network operator (MNO) or a mobile virtual network operator (MVNO) (e.g., Aeris network), the MNO or MVNO network can collect and provide this information to their customers to help them manage their devices and applications. It is very valuable to be able to collect and present information about what the device is doing inside of the data session including endpoints for each device and the amount of data that is exchanged with each endpoint by each device.

The system described herein collects information about the IP flows for customer devices, and make the IP flow data available to the customer(s) in near real time. In disclosed examples, the communication network joining the IP Flows captured from different network equipment, for example, Routers, Firewalls, etc. with AAA (authentication, authorization, and accounting) packet session data to identify which flows belong to which customer. Disclosed systems and methods further provide summary of all communications (using TCP, UDP, and/or other network protocols) between a customer's devices and a destination endpoint either on the Internet or in a private network, including information such as Source IP, Destination IP, bytes uploaded, bytes received, device location, etc.

Additionally, to make it convenient for customers to identify the destination hostnames, the DNS query logs are captured from the DNS servers and merged with the IP flows. Thus, the conversation details may include not just the destination IP but also the destination hostname. The capturing the IP flows and joining with AAA data is transparent across technologies (GSM, LTE, 5G, etc.), and is applicable for devices with static as well as dynamic IP addresses. Disclosed example systems and methods enable network and security administrators of the IoT communication network to collect and easily access usage data for an IoT deployment, and to quickly implement application access control rules and policies in response to the risks identified by networking monitoring, and/or proactively in accordance with Zero Trust security requirements. Access control policies that may be implemented at the network level in disclosed examples include: blocking (by default or by exception), suspending, and/or quarantining a device; defining allowed traffic lists and traffic blocking lists applicable to the entire enterprise and/or to devices belonging to service profiles; creating device (or user) specific policies controlling which applications the device can access; assigning various degrees of protection levels to a device or group of devices; and/or creating device (or user) specific policies controlling which public internet locations the device can access. In some examples, the access control policies are based on observed and/or predefined device (or user) behavior.

Being able to attribute traffic flow data to a device in a dynamic IP environment provides better awareness of security threats to customer(s) devices and data in a timely manner; ability to do sub-usage billing to customer(s); and diagnostic data to customer(s) about their devices.

Disclosed systems and methods allow enterprise customers or other service subscribers to identify anomalous activity by IoT devices to detect security threats; take corrective actions to block traffic against untrusted destination endpoints; analyze destination endpoints to generate diagnostic data to enterprise customers or other service subscribers about deployed IoT devices; and/or associate cost and/or billing with device endpoints (e.g., for sub-usage billing to enterprise customers or other service subscribers).

IoT device(s) typically connect to expected endpoints. Therefore, if the device connects to an endpoint other than the expected endpoint, something may be wrong. There is a high value in knowing that the device is connecting to the wrong endpoint as it may indicate presence of malware on the device. Similarly, IoT devices often follow a certain pattern of when they transmit data, such as once per hour, once per day etc. and hence any sudden change in such expected pattern may indicate a surge, or other problem, for example, a cloud server or backend server could be down. IoT devices that attempt to communicate to other devices may indicate a security threat such as a malware spread. For example, a malware attack may have infected one device, inducing it to try to connect to another device so the malware can reproduce. This may happen if a SIM card is stolen and installed into a system designed to hack into other devices on the network or into the cloud system behind the VPN. For example, if someone misuses the SIM card (e.g., theft) in a compromised device, the compromised device can now connect to other devices on the same network, and thus can also infect other devices. While the SIM card belongs to the legitimate device owned by the customer, the SIM card that is stolen and installed in a device that is not owned by the customer. The device with the stolen SIM can now access other devices on the network due to the network believing the device having the stolen SIM card is a legitimate device. In another scenario, applications running on a legitimate device gets hacked, thereby causing the device to connect to suspicious endpoints.

Conventionally, traffic blocking is based on usage, such as there is more than expected data usage. The devices may be blocked based on usage. Disclosed examples facilitate near real-time blocking based on the endpoints which have been discovered as an untrusted endpoints.

Usage analytics can be done across multiple dimensions: Destination Endpoint; Protocol (Network/Application); and Port Numbers.

Enterprises providing connected services often provide a gateway for their customers. This system allocates usage across their customers to restrict access and determine billing. Conventional networks, such as cellular service providers, use AAA data to bill the customers. Disclosed examples allow identification of connection endpoints within an IP packet session and thus provide the capability to use that data to bill by endpoint or by the device

Disclosed example systems and methods discretely identify IoT devices and assign policies to IoT devices, which remain consistently applied to the IoT device even if the IP address of the IoT device changes. Disclosed examples allow enforcement actions, such as blocking or throttling of an IoT device and/or individual applications operating on a device or group of devices. In some examples, enforcement action may be applied to all deployed devices, or a specified device group (e.g., selected model years on a car). Groups are user-definable, and can be created based on TAC codes of IMEI or other identifier, purposes, and/or behaviors. In some examples, enforcement at an application level includes applying data traffic decisions for based on specific applications running on an IoT device that executes multiple applications. For example, the enterprise customer may, at the network level, block transmissions from IoT device applications to a music service for a first group of IoT devices having a TAC code and lacking an associated subscription to the music service, while allowing transmissions for a second group of the IoT devices having the same TAC code but having an active subscription to the music service.

The term “network elements,” as used herein, refers to devices, servers, firmware, software (including cloud-based elements) and other types of attachments to a network.

The term “IoT device,” as used herein, refers to and includes cellular IoT devices, fixed wireless access (FWA) devices that provide wireless connectivity to other devices via a cellular network, and/or any other device configured to connect to a designated IoT network (whether via cellular or other network connection). For example, enterprise laptop devices may be configured to connect to the designated IoT network via a cellular connection and non-cellular connections. As used herein, the term “IoT device” does not include consumer phones.

According to aspects of this disclosure, example methods for monitoring IoT devices communicating via a communication network involve: collecting, via a communication network, data traffic associated with one or more IoT devices assigned to a subscription profile; identifying, via the communication network, anomalous communication behavior by individual ones of the IoT devices based on the data traffic and based on a mapping of a unique identifier of each of the IoT devices to an IP address; presenting information representative of the anomalous communication behavior for at least one of an individual one of the IoT devices or a group of the IoT devices to a user associated with the subscription profile; defining enforcement rules for at least one of an individual one of the IoT devices or a group of the IoT devices; assigning the enforcement rules to the IoT devices or a group of the IoT devices based on the mapping of the unique identifier of each of the IoT devices to the IP address; and controlling, via the communication network, data traffic of the IoT devices through the communication network based on the enforcement rules assigned to the IoT devices.

In some example methods, the communication network includes a cellular IoT network, and the IoT devices comprise cellular IoT devices. In some example methods, the IoT devices are configured to communicate with the communication network via multiple carrier networks. In some example methods, the unique identifier of each of the IoT devices comprises an IMSI of the IoT device, an ICCID of the IoT device, a MSISDN of the IoT device, or an IMEI of the IoT device.

Some example methods further involve identifying a group of IoT devices based on at least one of a TAC code, an access point name (APN), or a custom label applied to each of the IoT devices in the group. Some example methods further involve outputting at least one of a notification or an event to the user in response to identifying anomalous communication behavior based on comparing data traffic for the IoT device to at least one of an anomalous event definition or a normal behavior profile associated with the IoT device, the notification or the event identifying the IoT device and a type of event. In some example methods, the enforcement rule defines at least one of an application or an endpoint to be allowed or blocked for the IoT device or group of IoT devices. In some example methods, the controlling of the data traffic based on the enforcement rule comprises at least one of blocking or allowing a data packet or a DNS request.

Some example methods further involve presenting information representative of the data traffic for at least one of an individual one of the IoT devices or a group of the IoT devices to the user. Some example methods further involve assigning IP addresses to the IoT devices using dynamic assignment. In some example methods, the collecting of the data traffic comprises capturing and storing one or more of a source IP address associated with the data traffic, a destination IP address associated with the data traffic, a network protocol associated with the data traffic, a source port associated with the data traffic, a destination port associated with the data traffic, or a payload size associated with the data traffic.

In some example methods, the enforcement rules include at least one of blocking the data traffic, suspending the IoT device, or disconnecting the IoT device. In some example methods, at least one of the defining or the assigning of the enforcement rules is based on input from the user. In some example methods, the communication network includes a mobile network operator or a mobile virtual network operator. In some example methods, presenting information representative of anomalous and normal data traffic for the IoT device or the group of IoT devices to the user.

In some example methods, the information representative of anomalous and normal data traffic includes presenting a source IP address associated with the data traffic, a destination IP address associated with the data traffic, a network protocol associated with the data traffic, a source port associated with the data traffic, a destination port associated with the data traffic, or a payload size associated with the data traffic.

Some example methods further involve generating, via the communication network, anomalous event definitions for individual ones of the IoT devices, the anomalous event definitions being generated for ones of the IoT devices based on the data traffic. In some example methods, the generating of the anomalous event definitions comprises analyzing the data traffic using at least one of a machine learning model or heuristics. Some example methods further involve training the machine learning model on historical data traffic for the IoT device stored in a data repository. In some example methods, assigning the enforcement rules to one or more of the IoT devices or the group of IoT devices comprises associating one or more of the IoT devices with a traffic policy based on at least one of the unique identifier of the one or more of the IoT devices, an APN of the one or more of the IoT devices, a TAC code of the one or more of the IoT devices, or a custom label applied to the one or more of the IoT devices.

According to some aspects of this disclosure, example systems for monitoring IoT devices communicating via a communication network include: a packet core network configured to collect data traffic associated with one or more IoT devices assigned to a subscription profile; a traffic evaluation system configured to identify anomalous communication behavior by individual ones of the IoT devices based on the data traffic and based on a mapping of a unique identifier of each of the IoT devices to an IP address; and a rule enforcement system configured to: define enforcement rules for at least one of an individual one of the IoT devices or a group of the IoT devices; assign the enforcement rules to the IoT devices or a group of the IoT devices based on the mapping of the unique identifier of each of the IoT devices to the IP address; and control data traffic of the IoT devices through the packet core network based on the enforcement rules assigned to the IoT devices.

In some example systems, the packet core network includes a cellular IoT network, and the IoT devices comprise cellular IoT devices. In some example systems, the IoT devices are configured to communicate with the packet core network via multiple carrier networks. In some example systems, the unique identifier of each of the IoT devices comprises an IMSI of the IoT device, an ICCID of the IoT device, a MSISDN of the IoT device, or an IMEI of the IoT device. In some example systems, the traffic evaluation system is configured to identify a group of IoT devices based on at least one of a TAC code, an APN, or a custom label applied to each of the IoT devices in the group.

Some example systems further include a traffic awareness system configured to output at least one of a notification or an event in response to identifying anomalous communication behavior based on comparing data traffic for the IoT device to at least one of an anomalous event definition or a normal behavior profile associated with the IoT device, the notification or the event identifying the IoT device and a type of event. In some example systems, the enforcement rule defines at least one of an application or an endpoint to be allowed or blocked for the IoT device or group of IoT devices. In some example systems, the rule enforcement system is configured to control the data traffic based on the enforcement rule by controlling the packet core network to at least one of block or allow a data packet or a DNS request.

Some example systems further include a traffic awareness system configured to present information representative of the data traffic for at least one of an individual one of the IoT devices or a group of the IoT devices to the user. In some example systems, the packet core network is configured to assign IP addresses to the IoT devices using dynamic assignment. In some example systems, the packet core network is configured to collect the data traffic by capturing and storing one or more of a source IP address associated with the data traffic, a destination IP address associated with the data traffic, a network protocol associated with the data traffic, a source port associated with the data traffic, a destination port associated with the data traffic, or a payload size associated with the data traffic.

In some example systems, the enforcement rules include at least one of blocking the data traffic, suspending the IoT device, or disconnecting the IoT device. In some example systems, at least one of the defining or the assigning of the enforcement rules is based on input from the user. In some example systems, the packet core network includes a mobile network operator or a mobile virtual network operator.

Some example systems further include a traffic awareness system configured to present information representative of anomalous and normal data traffic for the IoT device or the group of IoT devices to the user. In some example systems, the information representative of anomalous and normal data traffic includes presenting a source IP address associated with the data traffic, a destination IP address associated with the data traffic, a network protocol associated with the data traffic, a source port associated with the data traffic, a destination port associated with the data traffic, or a payload size associated with the data traffic.

In some example systems, the traffic evaluation system is configured to generate anomalous event definitions for individual ones of the IoT devices, the anomalous event definitions being generated for ones of the IoT devices based on the data traffic. In some example systems, the traffic evaluation system is configured to generate the anomalous event definitions by analyzing the data traffic using at least one of a machine learning model or heuristics. In some example systems, the traffic evaluation system is configured to train the machine learning model on historical data traffic for the IoT device stored in a data repository.

In some example systems, the rule enforcement system is configured to assign the enforcement rules to one or more of the IoT devices or the group of IoT devices by associating one or more of the IoT devices with a traffic policy based on at least one of the unique identifier of the one or more of the IoT devices, an APN of the one or more of the IoT devices, a TAC code of the one or more of the IoT devices, or a custom label applied to the one or more of the IoT devices.

According to some aspects of this disclosure, example systems for controlling device communications for devices communicating via a communication network include: a network gateway configured to receive data traffic from an IoT device; and a rule enforcement system configured to: access an enforcement policy associated with the IoT device based on receipt of data traffic from the IoT device at the communications network, the enforcement policy defining applications and endpoints to be allowed or blocked, and a predefined malware protection level; in response to determining that the data traffic corresponds to the at least one allowed application, permit the data traffic to traverse the communications network; and in response to determining that the data traffic corresponds to the at least one blocked endpoint or the at least one allowed endpoint, allow or block the data traffic as defined in the enforcement rule.

In some example systems, the rule enforcement system is configured to block the data traffic from traversing the communications network, in response to determining that the data traffic has more than a threshold likelihood of being malicious traffic, the threshold likelihood being determined based on the selected malware protection level. In some example systems, the predefined malware protection level is selected from a plurality of predefined malware protection levels.

In some example systems, the rule enforcement system is configured to allow or block traffic by default when the data traffic does not correspond to the at least one allowed application and does not correspond to the at least one blocked endpoint or the at least one allowed endpoint. In some example systems, the rule enforcement system is configured to resolve conflicts between two or more of the at least one allowed application, the at least one blocked endpoint or the at least one allowed endpoint, and the malware protection level based on a precedence rule. In some example systems, at least one of the applications or endpoints are user-defined.

In some example systems, the enforcement policy is associated with the IoT device based on an association with a group of IoT devices including the IoT device. In some example systems, the group of IoT devices is defined based on at least one of a TAC code, an APN, or a custom label applied to each of the IoT devices in the group. In some example systems, the group of IoT devices is defined based on a user selection of devices to be included in the group.

In some example systems, the rule enforcement system is configured to apply the enforcement policy to the data traffic based on a mapping of a unique identifier of the IoT device to an IP address, and determining that the data traffic includes the IP address. In some example systems, the unique identifier is an IMSI of the IoT device, an ICCID of the IoT device, a MSISDN of the IoT device, or an IMEI of the IoT device.

According to aspects of this disclosure, example systems for monitoring devices communicating via a communication network include: a packet core network configured to route data traffic transmitted by IoT devices and data traffic transmitted to the IoT devices, and to log characteristic information about the data traffic in a data repository; a traffic evaluation system configured to generate anomalous event definitions for individual ones of the IoT devices based on associating the characteristic information about the data traffic to the individual ones of the IoT devices, the anomalous event definitions being generated for ones of the IoT devices based on the data traffic in the data repository associated with the corresponding ones of the IoT devices; and a traffic awareness system configured to determine, for each of the IoT devices, whether the data traffic transmitted by the IoT device or the data traffic in the data repository stored in association with the IoT device matches one or more of the anomalous event definitions associated with the IoT device.

In some example systems, the packet core network is configured to log, as the characteristic information, one or more of a source IP address associated with the data traffic, a destination IP address associated with the data traffic, a network protocol associated with the data traffic, a source port associated with the data traffic, a destination port associated with the data traffic, or a payload size associated with the data traffic. In some example systems, the packet core network is configured to associate the characteristic information with at least one of an IP address of the IoT device, an IMSI of the IoT device, an ICCID of the IoT device, a MSISDN of the IoT device, or an IMEI of the IoT device.

In some example systems, the traffic evaluation system is configured to generate the anomalous event definitions using at least one of a machine learning model trained using the data traffic in the data repository or heuristics. In some example systems, at least one of the anomalous event definitions is defined based on manual identification of at least one of an anomalous traffic event associated with the corresponding one of the IoT devices in the data traffic in the data repository or a known-good traffic event associated with the corresponding one of the IoT devices in the data repository.

In some example systems, the traffic evaluation system is configured to generate the anomalous event definitions based on designated business rules. In some example systems, the traffic evaluation system is configured to generate the anomalous event definitions to identify at least one of: one of the IoT devices transmitting to at least one of an IP address or a port to which that IoT device has not previously transmitted data, an address scan event, a port scan event, a threshold increase in data traffic from a set of one or more of the IoT devices, or an unauthorized use of a SIM by one of the IoT devices. In some example systems, the traffic evaluation system is configured to generate the anomalous event definitions for categories or groups of the IoT devices based on identifying a plurality of the IoT devices having shared characteristics.

In some example systems, the traffic awareness system is configured to evaluate the data traffic for each of the IoT devices based on the anomalous event definitions associated with that IoT device and based on the anomalous event definitions associated with a group of IoT devices including that IoT device. In some example systems, the traffic awareness system is configured to identify the group of IoT devices based on at least one of a TAC code, an APN, or a custom label applied to each of the IoT devices in the group.

In some example systems, the traffic awareness system is configured to output at least one of a notification or an event in response to identifying that the IoT device satisfies one of the anomalous event definitions, the notification or the event identifying the IoT device and a type of event. Some example systems further include a rule enforcement system configured to control the data traffic through the packet core network based on traffic policies corresponding to the IoT devices. In some example systems, the rule enforcement system is configured to control the packet core network to: permit data traffic from one of the IoT devices based on one or more applications identified in a corresponding one of the traffic policies; and drop data traffic from the one of the IoT devices that do not have a destination corresponding to the one or more identified applications.

In some example systems, the rule enforcement system is configured to define at least one of the one or more identified applications based on one or more anomalous event definitions corresponding to the one of the IoT devices. In some example systems, the rule enforcement system is configured to control the packet core network to do one or more of: permit data traffic from one of the IoT devices based on one or more first destination IP addresses identified in a corresponding one of the traffic policies; or drop data traffic from the one of the IoT devices based on one or more second destination IP addresses identified in the corresponding one of the traffic policies. In some example systems, the rule enforcement system is configured to control the packet core network to drop traffic associated with one or more predetermined threat types identified in a corresponding one of the traffic policies.

In some example systems, the rule enforcement system is configured to associate one or more of the IoT devices with one of the traffic policies based on at least one of an identifier of the one or more of the IoT devices, an APN of the one or more of the IoT devices, a TAC code of the one or more of the IoT devices, or a custom label applied to the one or more of the IoT devices. Some example systems further include a compliance monitor configured to log modifications to the traffic policies. In some example systems, the traffic awareness system is configured to generate a report identifying occurrences of the data traffic transmitted by the IoT device or the data traffic in the data repository stored in association with the IoT device matching the one or more of the anomalous event definitions associated with the IoT device. In some example systems, the traffic awareness system is configured to include a threat assessment of the occurrences based on threat assessment rules.

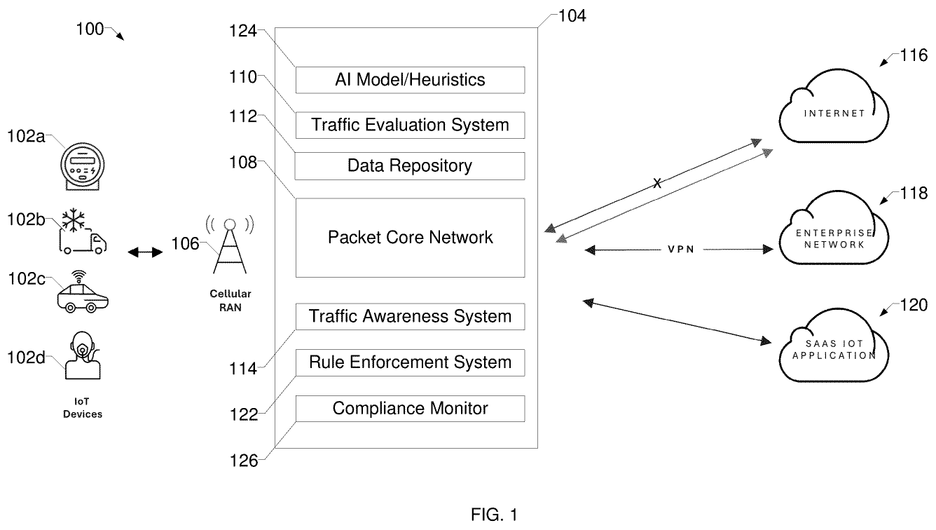

FIG. 1 is a schematic diagram of an example system 100 to secure IoT devices 102a-102d communicating via a cellular IoT network 104. The IoT devices 102a-102d include hardware, software, and/or firmware that allows the IoT devices 102a-102d to communicate with the cellular IoT network 104 via cellular access points 106. The cellular access points 106 may be controlled by a cellular carrier, or by a same entity that controls and manages the cellular IoT network 104.

The cellular IoT network 104 and the cellular access points 106 may be implemented using one or more communication architectures, methods, and networks, including but not limited to: Global System for Mobile Communications (GSM) (“GSM” is a trademark of the GSM Association), Universal Mobile Telecommunications System (UMTS), 4G LTE, 5G (including 5G RedCap), NB-IoT, wireless local area network (WIFI), and one or more wired networks. Messages containing commands, statuses, data, instructions, and/or any other desired information are transmitted between the IoT device 102a-102d and servers and/or other device(s) via the cellular IoT network 104. However, other types of carrier networks that may be accessed by IoT devices 102a-102d to access the cellular IoT network 104 may include satellite communication networks, lower-power wide area (LPWA) networks, and/or any other types of wired and/or short-range wireless, medium-range wireless, and/or long-range wireless communication networks that are accessible by IoT devices 102a-102d.

The cellular IoT network 104 includes a packet core network 108, a traffic evaluation system 110, a data repository 112, and a traffic awareness system 114.

The example packet core network 108 routes data traffic transmitted by IoT devices 102a-102d (referred to herein as Mobile Originated (MO) data traffic) and data traffic transmitted to the IoT devices 102a-102d (referred to herein as Mobile Terminated (MT) data traffic). As used herein, “data traffic” may include at least control plane traffic and data plane traffic, but may include additional types of data. The packet core network 108 may include any number of hardware and/or software-defined routers, wired and/or wireless connections between the routers, servers, and/or other network components to deliver data traffic from an originating cellular access point 106 to a gateway or access point connecting the packet core network 108 to another network. The cellular IoT network 104 may be connected to many cellular access points 106 across multiple locations and multiple carriers. Example networks which may be connected to the packet core network 108 include the public Internet 116, private networks 118, and/or host networks 120 for software applications which provide services or otherwise communicate with the devices 102a-102d. Any of the public Internet 116, private networks 118, and/or host networks 120 may include endpoints which provide services or otherwise may be accessed by the IoT devices 102a-102d in accordance with the configuration, function, and/or purpose of the IoT devices 102a-102d.

As the packet core network 108 routes data traffic, the packet core network 108 captures and stores characteristic information about the data traffic in the data repository 112. Example characteristic information that may be logged includes a timestamp, a source (e.g., transmitter, originating device) IP address, a destination (e.g., receiver) IP address, a source port, a destination port, a network protocol, and/or a payload size associated with the data traffic. Payload size may be monitored using a count of MO data (e.g., bytes transmitted) and/or a count of MT data (e.g., byte received). The example packet core network 108 associates the characteristic information with device-identifying information, such as an IP address, an IMSI, an ICCID, a MSISDN, and/or an IMEI of the IoT device 102a-102d, regardless of whether the IoT device 102a-102d is the source or the destination of the data traffic.

The characteristic information may be identified and stored in the packet core network 108 using an IP address information available from the data plane with device identifying information available from the control plane. While the IP address of a cellular IoT device 102a-102d, which is assigned by a management server of the cellular IoT network 104, may change many times over the service life of the cellular IoT device 102a-102d, the IMSI, ICCID, MSISDN, and/or IMEI identifiers are typically static. To associate data traffic with a given cellular IoT device 102a-102d, the packet core network 108 may obtain assignment or mapping data that relates an IP address of the cellular IoT device 102a-102d to the IMSI, ICCID, MSISDN, and/or IMEI for a given time period. For data traffic that is transmitted and received by the cellular IoT device 102a-102d, the packet core network 108 associates the characteristic information of the data traffic with the IP address information as well as the identifiers of the cellular IoT device 102a-102d based on the mapping data. Example systems and methods to map IP addresses (or other network assigned identifiers) to IMSI or IMEI identifiers (or other communication network subscription identifiers) are disclosed in U.S. Patent Publication No. 2022/0311768. The entirety of U.S. Patent Publication No. 2022/0311768 is incorporated by reference herein. In some examples, the IP addresses are assigned to the cellular IoT device 102a-102d by the cellular network carrier 106, rather than being selected from a pre-assigned range of IP addresses (e.g., a range of IP addresses assigned to a specific APN). In this manner, disclosed systems and methods can apply enforcement rules to IoT devices which change cellular networks or which may not otherwise be assigned an enforcement policy based on a predetermined range of IP addresses.

The characteristic information stored in the data repository 112 may be organized by endpoints, IP address, IMSI and/or other device identifiers, and/or using any other desired data. As described in more detail below, the characteristic information stored in the data repository 112 may be further organized based on groupings of the IoT devices 102a-102d. In some examples, the IoT devices 102a-102d are automatically and/or manually grouped based on identified characteristics of the IoT devices 102a-102d. Example grouping characteristics may include TAC code(s), APNs, and/or custom labels that are automatically and/or manually assigned to IoT devices 102a-102d based on business purpose, function, and/or any other criteria.

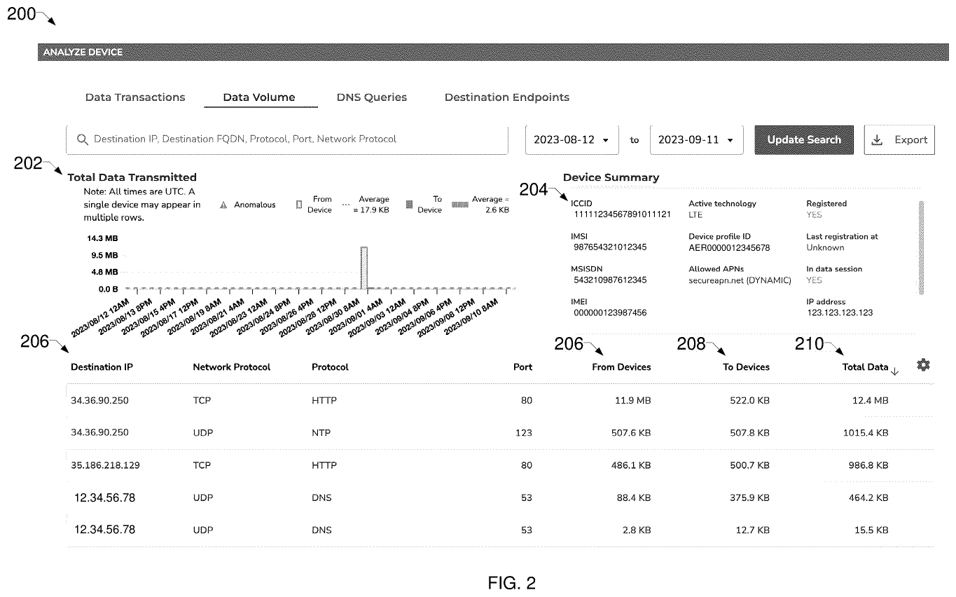

FIG. 2 illustrates an example user interface 200 that may be provided by the system 100 of FIG. 1 to access data traffic transmitted from (e.g., MO traffic) and/or transmitted to (e.g., MT traffic) an example IoT device 102a-102d, or group of IoT devices 102a-102d, connected to the cellular IoT network 104. The example user interface 200 illustrates a summary 202 of data traffic transmitted by a specific IoT device 102. As illustrated in FIG. 2, characteristic information about the data traffic is associated with identifiers 204 of the specific IoT device 102, including the ICCID, the IMSI, the MSISDN, the IMEI, and the IP address of the IoT device 102.

The example user interface 200 summarizes data traffic stored in the data repository 112 for the identified device 102, including totaling the quantity of MO data traffic 206 (e.g., Data “From Devices”), MT data traffic 208 (e.g., Data “To Devices”), and total data traffic 210 by destination IP address 212. The summary 202 further organizes the data traffic by network protocol, transfer protocol, destination port, source port, and/or any other characteristics.

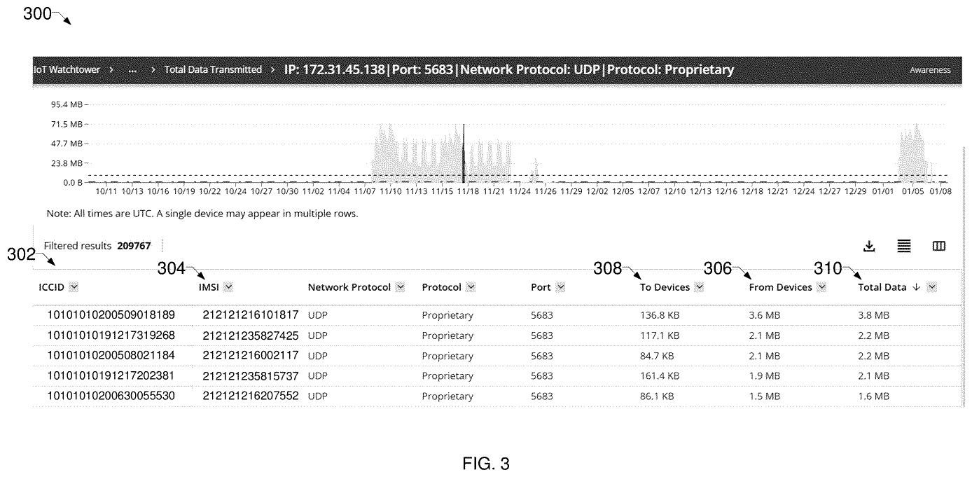

FIG. 3 illustrates another example user interface 300 that may be provided by the system 100 of FIG. 1 to access data traffic transmitted from and/or transmitted to multiple IoT devices 102a-102d connected to the cellular IoT network 104. The example user interface 200 illustrates a summary 302 of data traffic transmitted by multiple IoT devices to a specified IP address. As illustrated in FIG. 3, characteristic information about the data traffic is associated with identifiers 304 of the specific IoT device 102, including the ICCID and the IMSI, but may additionally or alternatively be associated with the MSISDN, the IMEI, and/or the IP address of the IoT device 102. Similarly to the example of FIG. 2, the user interface 300 summarizes data traffic including totaling the quantity of MO data traffic 306 (e.g., Data “From Devices”), MT data traffic 308 (e.g., Data “To Devices”), and total data traffic 310.

The example traffic evaluation system 110 accesses the characteristic information stored in the data repository 112. The traffic evaluation system 110 may perform statistical analyses of the traffic flows associated with individual IoT devices 102a-102d, groups of IoT devices 102a-102d, and/or any other organization. Example statistical information may include average data per transaction, total data transmitted, total DNS queries, and destination endpoints. Users can perform analysis of such statistics using filters, such as a defined time period.

The traffic statistics generated by the traffic evaluation system 110 enable the user to manually identify unexpected behaviors in traffic patterns of individual IoT devices 102a-102d and/or groups of IoT devices 102a-102d. For example, the traffic evaluation system 110 may use machine learning techniques (e.g., supervised and/or unsupervised machine learning) and/or heuristics 124 to analyze the characteristic information in the data repository 112 to identify patterns of behavior for individual IoT devices 102a-102d and/or for groups of IoT devices 102a-102d. While the machine learning techniques and/or heuristics 124 may be intentionally limited to defined groups, in some examples the machine learning techniques and/or heuristics 124 may be permitted to identify potential patterns of behavior in sets (e.g., ad hoc groups) of IoT device(s) 102a-102d that are not explicitly grouped (e.g., not grouped by characteristics at all, or spanning different groups). The machine learning techniques and/or heuristics 124 may analyze the raw characteristic information and/or may analyze the statistical information representing the characteristic information. The machine learning techniques and/or heuristics 124 may be provided with supplemental data describing the business purpose, location, function, and/or any other information that may be potentially relevant to identifying expected or normal behavior by the IoT devices 102a-102d and, by corollary, anomalous behavior by the IoT devices 102a-102d. The traffic evaluation system 110 may analyze data by time period to identify patterns, such as different patterns over the course of a given day (e.g., morning/evening patterns), patterns for holidays, weekend, and/or business days, and/or on a rolling window of a predetermined time period (e.g., 60 days, 90 days, etc.).

Using the data traffic in the data repository 112 associated with the corresponding ones of the IoT devices 102a-102d, using patterns recognized via the machine learning techniques and/or heuristics 124, and/or using manually identified patterns or data, the example traffic evaluation system 110 generates anomalous event definitions for individual ones of the IoT devices 102a-102d, for automatically and/or manually assigned groups of the IoT devices 102a-102d, and/or for ad hoc groups of the IoT devices 102a-102d. Example anomalous event definitions that may be generated by the traffic evaluation system 110 may identify one of the IoT devices 102a-102d transmitting to at least one of an IP address or a port to which that IoT device has not previously transmitted data (e.g., a novel IP address and/or a novel port), an address scan event, a port scan event, a threshold increase in data traffic from a set of one or more of the IoT devices 102a-102d, and/or an unauthorized use of a SIM by one of the IoT devices 102a-102d. As used herein, “anomalous events” includes data traffic that is merely anomalous or unusual compared to normal traffic patterns for the relevant device(s), suspicious data traffic that exhibits an enhanced resemblance to problematic or malicious behavior, and/or data traffic that exhibits or resembles behavior known to be malicious in nature or unauthorized. Anomalous event definitions identify one or more observable criteria for determining whether data traffic is deemed an anomalous event. In some examples, the traffic evaluation system 110 generates the anomalous event definitions for categories or groups of the IoT devices 102a-102d based on identifying multiple ones of the IoT devices 102a-102d having the same or shared characteristics (e.g., TAC code, custom label, location, access point, applications, APN, etc.). Location may include a home (or default) zone or network cell, country, home network access point, and/or any other type of location specification.

Anomalous event definitions may also be generated and/or informed using business rules, which may be input by a user or otherwise imported. As used herein, “business rules” includes any information that describes the function or purpose of the device, and/or which can inform the intended functionality of the device for purposes of determining anomalous behavior. In some examples, the traffic evaluation system 110 generates normal behavior definitions in addition to or instead of the anomalous event definitions. Normal behavior definitions may define expected ranges of communication behavior by an IoT device 102a-102d or group of IoT devices 102a-102d.

In addition or as an alternative to generating anomalous event definitions, the traffic evaluation system 110 may apply threat intelligence rules to identify anomalous events in data traffic. Threat intelligence rules may be directed primarily or exclusively toward behavior known or previously observed to be malicious, and may be created and/or adapted using up-to-date third-party commercial threat intelligence and/or other threat intelligence sources.

The example traffic awareness system 114 determines, for each of the IoT devices 102a-102d, whether the data traffic transmitted by the IoT devices 102a-102d (e.g., data traffic being accepted into and/or traversing the packet core network 108), and/or the data traffic represented in the data repository 112 (e.g., characteristic information for data traffic associated with the IoT devices 102a-102d), matches one or more of the anomalous event definitions associated with the IoT device(s) 102a-102d with which the anomalous event definition is associated.

In the case of data traffic traversing the packet core network 108, the example traffic awareness system 114 decides whether to allow or drop (e.g., block) the data traffic from entering or traversing the packet core network 108 based on an enforcement policy, including the use of default blocking. As disclosed in more detail below, enforcement policies may be defined and/or applied for individual IoT devices 102a-102d and/or groups of IoT devices 102a-102d, and may be configured at least partially based on the anomalous event definitions generated for that individual IoT device 102a-102d and/or group of IoT devices 102a-102d. Characteristic information for blocked traffic may still be collected and stored by the packet core network 108 for diagnostics or other analysis.

In some examples, a user may override or dismiss identified anomalous events, such as when the user has investigated the underlying cause of the identified anomalous event and determined the anomalous event to be expected or otherwise low risk behavior. For example, an authorized user can dismiss and suppress future events based on additional criteria such as endpoint IP address, scanned subnet, and ports. Dismissal or suppression may be conditioned on, for example, the amount of traffic involved in the event. In disclosed examples, user interfaces provide convenient dismissal or suppression to enable users to easily reduce noise in identified anomalous events. The AI model/heuristics 124 may use dismissal or suppression decisions as “known-good” decisions to further train or inform anomalous event definitions.

In the case of characteristic information representative of data traffic that has already occurred, the example traffic awareness system 114 permits real-time access by authorized users and generates a threat assessment report for output to one or more users. The threat assessment report may include specific anomalous events, patterns of anomalous behavior, severity of anomalous events, and/or suggested remedial actions. Example threat assessment reports that may be generated by the traffic awareness system 114 identify occurrences of the data traffic transmitted by the IoT devices 102a-102d and/or the data traffic in the data repository 112 (stored in association with the IoT devices 102a-102d) matching one or more of the anomalous event definitions associated with the IoT device. Anomalous events and/or behavior patterns may be organized by endpoints, IP address, IMSI and/or other device identifiers, and/or custom labels or other information. The traffic awareness system 114 may generate threat assessment reports periodically, aperiodically, in response to particular events or other triggers, and/or on demand by a user. The traffic awareness system 114 may store historical threat assessment reports for later access, such as auditing or other archival purposes.

For either of data traffic traversing the packet core network 108, or data traffic that has already occurred, the traffic awareness system 114 may output a notification or an event in response to identifying that one of the IoT devices 102a-102d satisfies one of the anomalous event definitions for the IoT device 102a-102d or for a group to which the IoT device 102a-102d is a member. The notification or the event identifies the IoT device 102a-102d and a type of the event, such as whether the event is anomalous, suspicious, or malicious, as well as additional detail about the reasons the event satisfied the anomalous event definition.

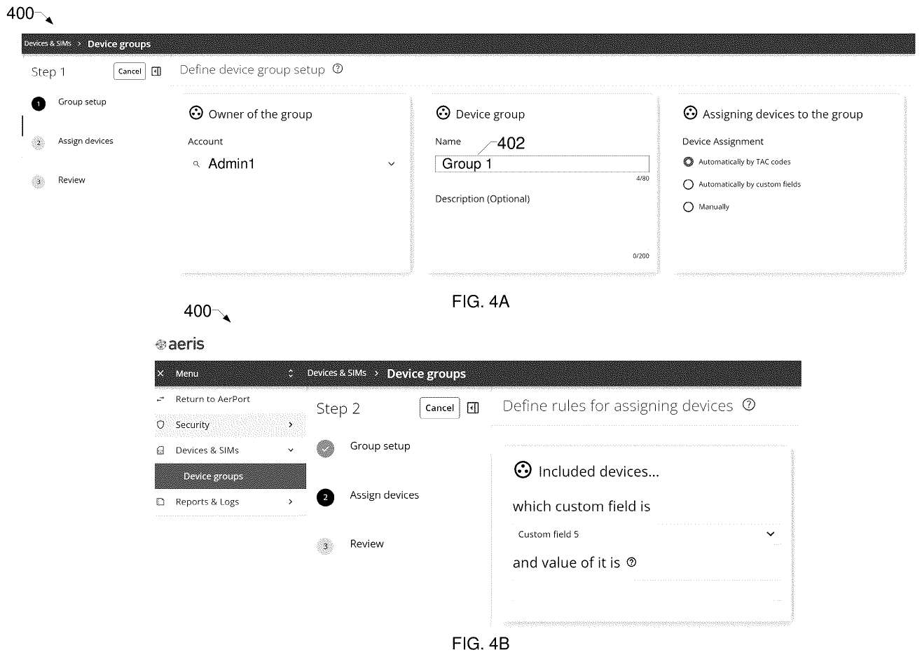

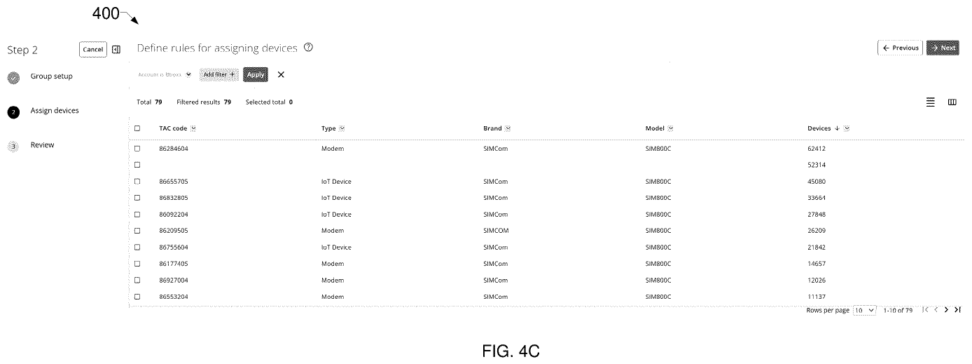

FIG. 4A illustrates an example user interface 400 that may be provided by the system 100 of FIG. 1 to group a set of IoT devices 102a-102d for traffic monitoring and/or policy enforcement based on specified criteria.

The example user interface 400 permits the user to specify a name, title, or other identifier 402 of the generated group. The user interface 400 further allows the user to assign selected ones of the IoT devices 102a-102d to the generated group manually or automatically based on one or more predefined criteria (e.g., automatically by TAC code, APN, application, hardware model, or other predefined criteria), automatically based on custom labels or other metadata applied to the IoT devices 102a-102d, manually, and/or using any other selection method. The custom labels or metadata may be automatically assigned and/or manually assigned to devices 102a-102d by a user, by a manufacturer, and/or by any other entity. Example custom labels, fields, or metadata may include descriptors of function (e.g., H2Osensor, coffeeVending, truckTracker, objectTracker, etc.), business unit or purpose (e.g., operationsDept, shippingDept, billingDept, etc.), and/or any other custom label or metadata desired to be applied.

FIG. 4B illustrates the example user interface 400 of FIG. 4A that may be provided by the system 100 of FIG. 1 to group the set of IoT devices 102a-102d. In the example of FIG. 4B, which may be provided to the user in response to selection of custom field method for selecting ones of the IoT devices 102a-102d for inclusion in the group. The user interface 400 allows the user to select which of multiple defined fields is to be used for grouping, and to select or define the value of the selected field to cause ones of the IoT devices 102a-102d to be added to the group.

FIG. 4C illustrates the example user interface 400 of FIG. 4A that may be provided by the system 100 of FIG. 1 after defining initial selection criteria for including ones of the IoT devices 102a-102d in a group. The IoT devices 102a-102d selected based on the TAC code, custom label, or manual selection may be further filtered to select a set of the IoT devices 102a-102d that are desired to have a common monitoring and/or enforcement policy. In some examples, the traffic awareness system 114 subsequently includes in the defined group any IoT devices 102a-102d that are connected to the cellular IoT network 104 after the group is defined.

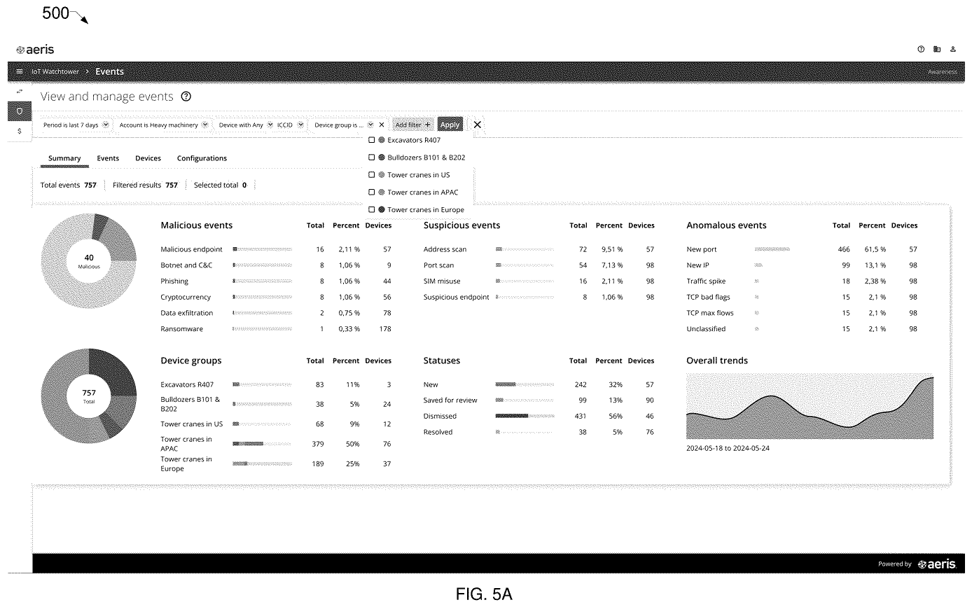

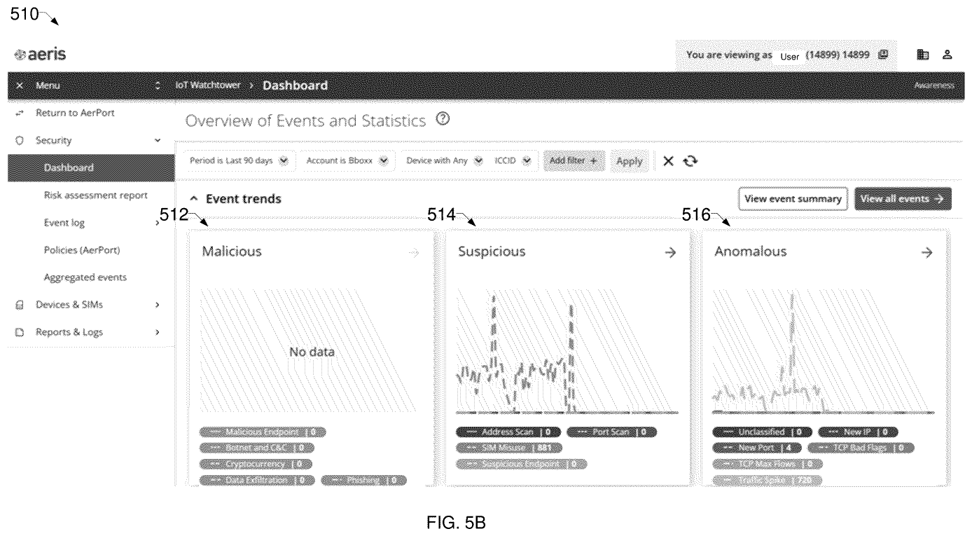

FIG. 5A illustrates an example user interface 500 that may be provided by the system 100 of FIG. 1 to summarize anomalous traffic for groups of devices. The example user interface 500 may summarize identified malicious events, suspicious events, and/or anomalous events based on applying corresponding anomalous event definitions to the IoT devices 102a-102d included in the defined group(s). In the example of FIG. 5A, the system 100 may further aggregate or summarize anomalous traffic for multiple selected groups.

FIG. 5B illustrates another example user interface 510 that may be provided by the system of FIG. 1 to summarize anomalous traffic for all IoT devices for a subscriber profile. In the example of FIG. 5B, the interface 510 illustrates a malicious behavior summary 512, a suspicious behavior summary 514, and a malicious behavior summary 516. A user may select any of the summaries 512-516 to be presented with more detail, data, and/or analysis of the selected type of behavior, including the devices associated with the behaviors. The summaries 512-516 shown in the user interface 510 may be filtered by time period, group, account, type of device, TAC code, and/or any other desired filtering.

Returning to FIG. 1, the example cellular IoT network 104 includes a rule enforcement system 122 which controls the data traffic through the packet core network 108 based on traffic policies corresponding to the IoT devices 102a-102d. Network and security policy administrator users including, without limitation, can create security policies in response to identified risks and/or anomalies identified by the traffic evaluation system 110 (e.g., anomalous event definitions), and/or proactively based on the business context(s) of the IoT devices 102a-102d and endpoints used by the IoT devices 102a-102d (e.g., the public Internet 116, the private network 118, the host network 120, etc.). Policies can be defined for all IoT devices 102a-102d managed by an account, based on service profiles of the IoT devices 102a-102d, and/or based on any other organizational structure. The example IoT network 104 allows Zero Trust access to the cellular IoT domain, in part by implementing granular network policies across a set of heterogenous cellular network carriers 106 based on identity models (e.g., device identities, by layer 3 and layer 4 IP fields (source and destination IP, port and protocol)). Policy actions that may be taken by the rule enforcement system include allowing and blocking data traffic, throttling traffic, and/or setting up default rules. Policies can be defined based on an observed anomaly or event, and/or by selecting from observed known-good traffic events. Additionally, the rule enforcement system 122 may use defined malware protection policies to flag and/or block traffic based on suspicious traffic events.

The example rule enforcement system 122 may be implemented using components of a traffic control function, such as the Aeris Packet Function. An example traffic control function, such as the Aeris Packet Function, is disclosed in U.S. Patent Publication No. 2022/0311768.

In some examples, the rule enforcement system 122 implements a malware protection policy that prevents malware from being downloaded if the download is identified as originating from a known malicious endpoint, prevents malware present on the IoT devices 102a-102d from performing communication functions (e.g., communicating with command and control servers), and/or prevents phishing and/or ransomware attacks.

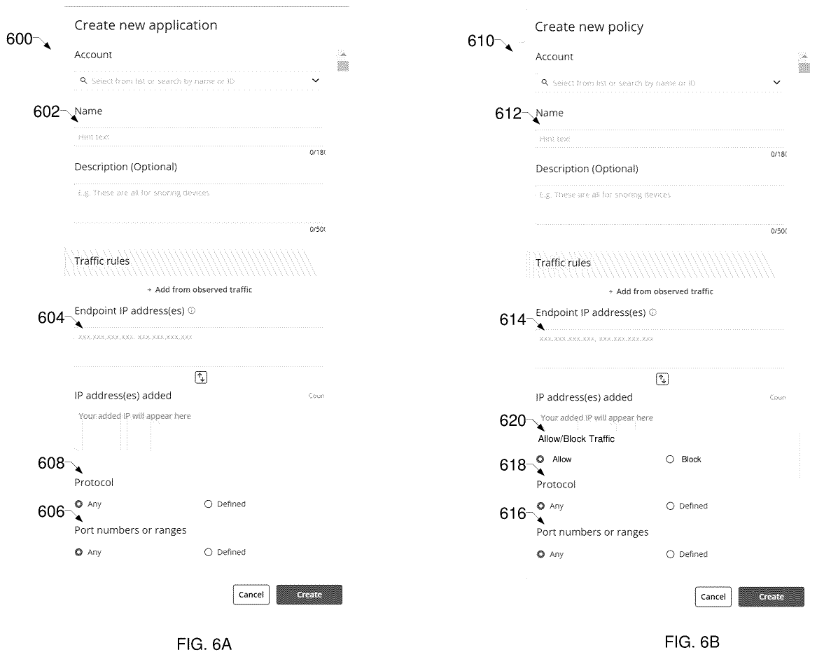

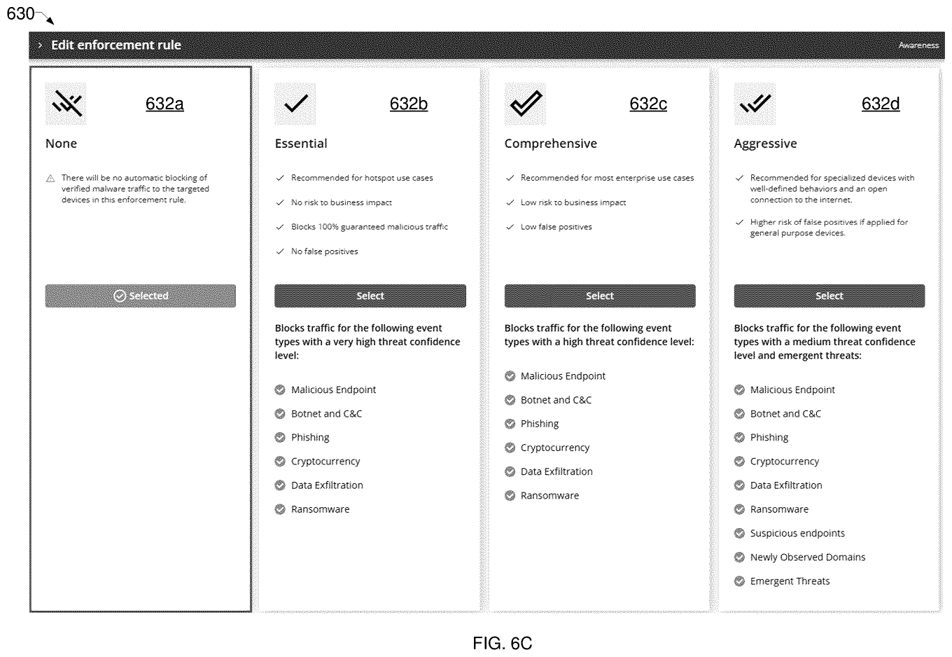

FIGS. 6A-6C illustrate example user interfaces that may be provided by the system 100 of FIG. 1 to create an enforcement policy for one or more IoT devices 102a-102d connected to the cellular IoT network 104.

FIG. 6A illustrates an example user interface 600 which enables a user to define an application (e.g., a network server, a SaaS application, etc.) which may explicitly be accessed by one or more cellular IoT devices 102a-102d to which the enforcement policy is applied. The example user interface 600 includes fields for a name 602 (e.g., a title) of the application, which may be the name assigned to the application or service or an informal name that may be easier for the user to remember. The user interface 600 allows access to the application to be defined using, for example, one or more IP addresses 604, protocols 606, and/or port numbers 608 of the application. Additionally or alternatively, the user interface 600 may allow access to the traffic evaluation system 110 to import IP addresses that have previously been used by the cellular IoT device 102a-102d (e.g., the destination IP addresses displayed in FIGS. 2 and/or 3 in association with observed traffic).

Based on the identified IP addresses and/or other information, the example rule enforcement system 122 may create or supplement an application traffic policy used to control the packet core network 108. Based on the application traffic policy, the rule enforcement system 122 controls the packet core network 108 to permit data traffic from the applicable ones of the cellular IoT devices 102a-102d based on one or more applications identified in the corresponding application traffic policy, and/or drops data traffic from the applicable ones of the cellular IoT devices 102a-102d that do not have a destination corresponding to the one or more identified applications.

FIG. 6B illustrates another example user interface 610 which enables a user to define a destination (e.g., a public network endpoint, a private network endpoint, etc.) which may explicitly be accessed or blocked by one or more cellular IoT devices 102a-102d to which the enforcement policy is applied. The example user interface 610 includes similar elements as the user interface 600 of FIG. 6A, including fields to define name 612, IP address(s) 614 and port numbers 616 of the destination, and/or protocols 618 for a protection traffic policy. The example user interface 610 further includes an allow/block selection that defines the action to be taken by the rule enforcement system 122 when data traffic satisfies the protection traffic policy. The user interface 610 permits the user to define any number of endpoints or destinations for allowing and blocking traffic from the corresponding cellular IoT devices 102a-102d to which the enforcement policy is applied.

Based on the protection traffic policy, the rule enforcement system 122 controls the packet core network 108 to permit data traffic from the applicable ones of the cellular IoT devices 102a-102d based on zero or more endpoints (e.g., IP addresses) defined for allowing in the corresponding protection traffic policy, and/or drops data traffic from the applicable ones of the cellular IoT devices 102a-102d based on zero or more endpoints (e.g., IP addresses) defined for blocking in the corresponding protection traffic policy.

FIG. 6C illustrates another example user interface 630 which enables a user to select a threat traffic policy from two or more predefined threat traffic policies 632a-632d with different levels of detection sensitivity. The example user interface 630 provides the predefined threat traffic policies 632a-632d as selections. Each of the example predefined threat traffic policies 632a-632d represents a different set of rules (representing a different level of detection sensitivity) associated with anomalous traffic patterns, known threats, known threat types, and/or threat intelligence. For example, a first threat traffic policy 632a (“None”) for a cellular IoT device 102a-102d corresponds to permitting traffic determined by threat intelligence to be known, or sufficiently likely, to be malicious traffic. A second example threat traffic policy 632b (“Essential”) corresponds to blocking traffic determined by threat intelligence to be known, or sufficiently highly likely (e.g., above a highest likeliness threshold), to be malicious traffic, and allowing traffic that does not meet the corresponding likeliness threshold.

A third example threat traffic policy 632c (“Comprehensive”) corresponds to blocking traffic determined by threat intelligence to be known, or sufficiently likely (e.g., above an intermediate likeliness threshold, which may still correspond to a high likeliness), to be malicious traffic, and allowing traffic that does not meet the corresponding likeliness threshold. A fourth example threat traffic policy 632d (“Aggressive”) corresponds to blocking traffic determined by threat intelligence to be known, or sufficiently likely (e.g., above a lower likeliness threshold, which may still be moderately high), to be malicious traffic, and allowing traffic that does not meet the corresponding likeliness threshold. In some examples, more aggressive threat intelligence results in incorrectly identifying more traffic as malicious (false positives) based on the threat intelligence rules and thresholds.

In some examples, the rule enforcement system 122 combines the application traffic policy, the protection traffic policy, and/or the threat traffic policy for a cellular IoT device 102a-102d into an enforcement rule for that cellular IoT device 102a-102d. The example rule enforcement system 122 controls the packet core network 108 based on the enforcement rules to allow and block traffic for each cellular IoT device 102a-102d based on the enforcement rule (e.g., the application traffic policy, the protection traffic policy, and/or the threat traffic policy) that is assigned to that cellular IoT device 102a-102d. The rule enforcement system 122 further logs the allow/block decisions for subsequent reporting and/or analysis by users, which can be performed to adjust the policies to meet the business requirements.

In some examples, administrative users may be provided with different levels of permission to view or change the anomalous event definitions and/or to view or change the enforcement rules. In this manner, an IoT deployment owner (e.g., an enterprise customer) can permit some users to change the anomalous event definitions, the enforcement rules, or both, to facilitate improved self-management of the security of the IoT deployment. The IoT deployment owner can also permit some users to view the anomalous event definitions, the enforcement rules, or both, to facilitate investigations of anomalies or other potential security issues identified by the traffic awareness system 114. IoT deployment owners may be organized or identified using a subscriber profile, to which the IoT devices 102a-102d are assigned during provisioning.

In some examples, the rule enforcement system 122 may apply an enforcement rule, and/or one or more of the application traffic policy, the protection traffic policy, and/or the threat traffic policy, to multiple cellular IoT devices 102a-102d. For example, the rule enforcement system 122 may apply enforcement rules to ones of the cellular IoT devices 102a-102d that have a same TAC code, belong to a same APN, belong to a same subscription or service plan, and/or any other characteristic(s) or criteria, or any combination of a same TAC code, a same APN, a same subscription or service plan, and/or any other characteristic(s) or criteria. The rule enforcement system 122 may limit individual cellular IoT devices 102a-102d to a single enforcement rule or may apply multiple enforcement rules to one cellular IoT device 102a-102d (with appropriate conflict resolution rules). The rule enforcement system 122 may perform the allow/block decisions at access points between the IoT devices 102a-102d and the packet core network 108. Accordingly, the rule enforcement system 122 may allow for grouping of IoT devices 102a-102d for application of enforcement policies by APN. Grouping may further be based on other characteristics, such as service plan, TAC code, or other characteristics or identifiers.

The enforcement rule may include a default permit decision or a default block decision, in which data traffic that is not matched with any of the application traffic policy, the protection traffic policy, or the threat traffic policy is allowed or blocked in accordance with the default decision. The enforcement rules may include a precedence rule that defines which of the application traffic policy, the protection traffic policy, and the threat traffic policy has priority in the event of a conflict between the policies. In some examples, the precedence policy may also define the order of evaluation of the application traffic policy, the protection traffic policy, and the threat traffic policy, in which the first one of the policies that results in a matching rule is enforced.

In some examples, the traffic awareness system 114 permits users to dismiss or disable anomalous events. Dismissing an event will allow a user to take policy action in terms of disabling such events from appearing as anomalies (e.g., temporarily, for a selected time, indefinitely, etc.). Disabling an event allows a user to remove the anomalous event definition. By configuring network security policies, the administrator user can control the rule enforcement system 122 to proactively protect assets (e.g., IoT devices 102a-102d) from being compromised and/or to prevent compromised assets from performing certain undesired anomalous actions, thereby reducing risk and attack surface.

The example rule enforcement system 122 can control the packet core network 108 (e.g., via access points) to perform actions at an individual IoT device level in response to risks and anomalies identified by the traffic evaluation system 110. For example, the rule enforcement system 122 can control the packet core network 108 to block an IoT device 102a-102d by selectively disabling the IoT devices 102a-102d from accessing specific network services (e.g. SMS, voice, data), and/or blocking selected applications on the IoT devices from accessing one or more server applications and/or endpoints. The rule enforcement system 122 can also control the packet core network 108 to suspend a IoT device 102a-102d by blocking any traffic to and from the suspended IoT device 102a-102d. The rule enforcement system 122 can also control the packet core network 108 to cancel a IoT device 102a-102d by detaching the device IoT device 102a-102d from the cellular IoT network 104. Using device level enforcement, the rule enforcement system 122 limits exposure of potential security threats and/or business risks to an individual IoT device 102a-102d and/or a set of IoT devices 102a-102d, and can thereby prevent that IoT device 102a-102d from being used against other assets, such as other IoT devices 102a-102d and servers.

The example cellular IoT network 104 may include additional elements not discussed herein, such as servers to perform device registration, authorization, and/or management.

The example cellular IoT network of FIG. 1 further includes a compliance monitor 126 configured to log modifications to traffic policies. Any of the example the packet core network 108, the traffic evaluation system 110, the data repository 112, the traffic awareness system 114, the rule enforcement system 122, the AI model/heuristics service 124, and/or any other components of the cellular IoT network 104 may, via the compliance monitor 126, log or otherwise store information about user activities related to access management, anomalous event definition configuration or modification, actions related to the cellular IoT devices 102a-102d (e.g., quarantining, disconnection, etc.), device configurations, group configurations (e.g., creation, modification, deletion), policy configurations and/or application (e.g., assigning devices and/or groups to enforcement rules), and/or any other security actions. The logged information may be retained to enable a fast and accurate auditing process to ensure regulatory compliance.

The example cellular IoT network 104 may be replicated across multiple cellular carriers or networks to provide consistent detection and/or enforcement across multiple regions. For example, the cellular IoT network 104 may orchestrate the anomalous event definitions and/or enforcement rules for multiple instances of the cellular IoT network 104 for a given deployment, thereby allowing devices connected via different carriers to benefit from a faster network connection. Additionally, a device which moves from one carrier region to another carrier region is subject to the same anomalous event definitions and/or enforcement rules.

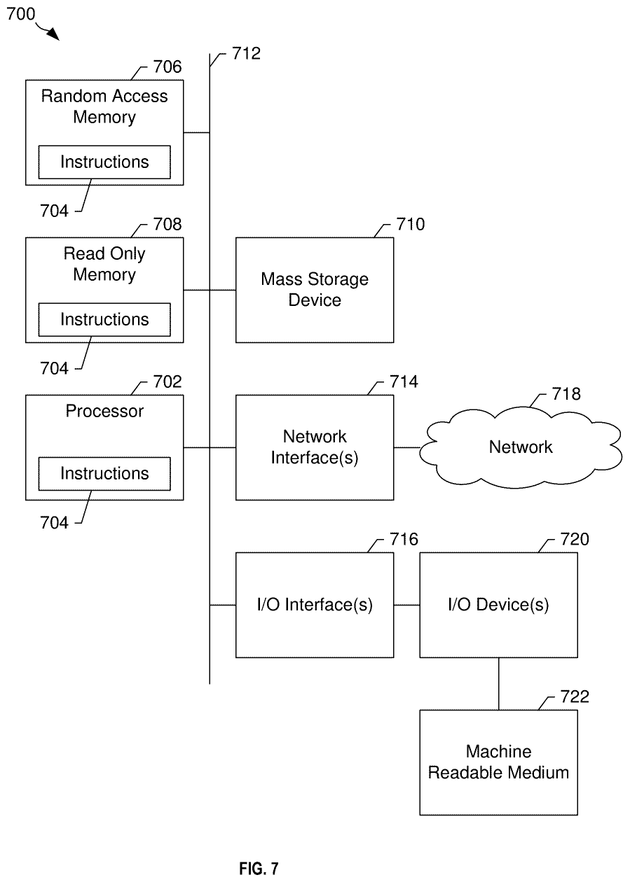

FIG. 7 is a block diagram of an example computing system 700 that may be used to implement any of the IoT devices 102a-102d, components of the packet core network 108 (e.g., routers, gateways, etc.), the traffic evaluation system 110, the data repository 112, the traffic awareness system 114, the rule enforcement system 122, the AI model/heuristics service 124, and/or endpoints of the networks 116-120 of FIG. 1. The example computing system 700 may be implemented using a personal computer, a server, a smartphone, a laptop computer, a workstation, a tablet computer, and/or any other type of computing device.

The example computing system 700 of FIG. 7 includes a processor 702. The example processor 702 may be any general purpose central processing unit (CPU) from any manufacturer. In some other examples, the processor 702 may include one or more specialized processing units, such as RISC processors with an ARM core, graphic processing units, digital signal processors, and/or system-on-chips (SoC). The processor 702 executes machine readable instructions 704 that may be stored locally at the processor (e.g., in an included cache or SoC), in a random access memory 706 (or other volatile memory), in a read only memory 708 (or other non-volatile memory such as FLASH memory), and/or in a mass storage device 710. The example mass storage device 710 may be a hard drive, a solid state storage drive, a hybrid drive, a RAID array, and/or any other mass data storage device.

A bus 712 enables communications between the processor 702, the RAM 706, the ROM 708, the mass storage device 710, a network interface 714, and/or an input/output interface 716.

The example network interface 714 includes hardware, firmware, and/or software to connect the computing system 700 to a communications network 718 such as the Internet. For example, the network interface 714 may include IEEE 702.X-compliant wireless and/or wired communications hardware for transmitting and/or receiving communications.

The example I/O interface 716 of FIG. 7 includes hardware, firmware, and/or software to connect one or more input/output devices 720 to the processor 702 for providing input to the processor 702 and/or providing output from the processor 702. For example, the I/O interface 716 may include a graphics processing unit for interfacing with a display device, a universal serial bus port for interfacing with one or more USB-compliant devices, a FireWire, a field bus, and/or any other type of interface. Example I/O device(s) 720 may include a keyboard, a keypad, a mouse, a trackball, a pointing device, a microphone, an audio speaker, an optical media drive, a multi-touch touch screen, a gesture recognition interface, a display device, a magnetic media drive, and/or any other type of input and/or output device.

The example computing system 700 may access a non-transitory machine readable medium 722 via the I/O interface 716 and/or the I/O device(s) 720. Examples of the machine readable medium 722 of FIG. 7 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

Example wireless interfaces, protocols, and/or standards that may be supported and/or used by the network interface(s) 714 and/or the I/O interface(s) 716, include wireless personal area network (WPAN) protocols, such as Bluetooth (IEEE 702.15); near field communication (NFC) standards; wireless local area network (WLAN) protocols, such as WiFi (IEEE 702.11); cellular standards, such as 2G/2G+ (e.g., GSM/GPRS/EDGE, and IS-95 or cdmaOne) and/or 2G/2G+ (e.g., CDMA2000, UMTS, and HSPA); 4G standards, such as WiMAX (IEEE 702.16) and LTE; 5G standards; Ultra-Wideband (UWB); etc. Example wired interfaces, protocols, and/or standards that may be supported and/or used by the network interface(s) 714 and/or the I/O interface(s) 716, such as to communicate with the display device(s), include comprise Ethernet (IEEE 702.3), Fiber Distributed Data Interface (FDDI), Integrated Services Digital Network (ISDN), cable television and/or internet (ATSC, DVB-C, DOCSIS), Universal Serial Bus (USB) based interfaces, etc.

The processor 702, the network interface(s) 714, and/or the I/O interface(s) 716 may perform signal processing operations such as, for example, filtering, amplification, analog-to-digital conversion and/or digital-to-analog conversion, up-conversion/down-conversion of baseband signals, encoding/decoding, encryption/decryption, modulation/demodulation, and/or any other appropriate signal processing.

The computing system 700 may use one or more antennas for wireless communications and/or one or more wired port(s) for wired communications. The antenna(s) may be any type of antenna (e.g., directional antennas, omnidirectional antennas, multi-input multi-output (MIMO) antennas, etc.) suited for the frequencies, power levels, diversity, and/or other parameters required for the wireless interfaces and/or protocols used to communicate. The port(s) may include any type of connectors suited for the communications over wired interfaces/protocols supported by the computing system 700. For example, the port(s) may include an Ethernet over twisted pair port, a USB port, an HDMI port, a passive optical network (PON) port, and/or any other suitable port for interfacing with a wired or optical cable.

While disclosed examples refer to “user” input, such as user selection, user definition, and/or any other action that can be taken via a user interface, the disclosed examples are not limited to human users. Instead, disclosed examples may take user input from autonomous agents, such as AI-powered agents, for selection of devices, definitions of enforcement policies, and/or any other user input or action disclosed herein. As such, the term “user,” as used herein, refers to and includes both humans and autonomous agents.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A method for monitoring IoT devices communicating via a communication network, the method comprising:
collecting, via a communication network, data traffic associated with one or more IoT devices assigned to a subscription profile;
identifying, via the communication network, anomalous communication behavior by individual ones of the IoT devices based on the data traffic and based on a mapping of a unique identifier of each of the IoT devices to an IP address;
presenting information representative of the anomalous communication behavior for at least one of an individual one of the IoT devices or a group of the IoT devices to a user associated with the subscription profile;
defining enforcement rules for at least one of an individual one of the IoT devices or a group of the IoT devices;
assigning the enforcement rules to the IoT devices or a group of the IoT devices based on the mapping of the unique identifier of each of the IoT devices to the IP address; and
controlling, via the communication network, data traffic of the IoT devices through the communication network based on the enforcement rules assigned to the IoT devices.

2-20. (canceled)

21. A system for monitoring IoT devices communicating via a communication network, the system comprising:
a packet core network configured to collect data traffic associated with one or more IoT devices assigned to a subscription profile;
a traffic evaluation system configured to identify anomalous communication behavior by individual ones of the IoT devices based on the data traffic and based on a mapping of a unique identifier of each of the IoT devices to an IP address; and
a rule enforcement system configured to:
define enforcement rules for at least one of an individual one of the IoT devices or a group of the IoT devices;
assign the enforcement rules to the IoT devices or a group of the IoT devices based on the mapping of the unique identifier of each of the IoT devices to the IP address; and
control data traffic of the IoT devices through the packet core network based on the enforcement rules assigned to the IoT devices.

22. The system as defined in claim 21, wherein the packet core network comprises a cellular IoT network, and the IoT devices comprise cellular IoT devices.

23. The system as defined in claim 21, wherein the IoT devices are configured to communicate with the packet core network via multiple carrier networks.

24. The system as defined in claim 21, wherein the unique identifier of each of the IoT devices comprises an IMSI of the IoT device, an ICCID of the IoT device, a MSISDN of the IoT device, or an IMEI of the IoT device.

25. The system as defined in claim 21, wherein the traffic evaluation system is configured to identify a group of IoT devices based on at least one of a TAC code, an APN, or a custom label applied to each of the IoT devices in the group.

26. The system as defined in claim 21, further comprising a traffic awareness system configured to output at least one of a notification or an event in response to identifying anomalous communication behavior based on comparing data traffic for the IoT device to at least one of an anomalous event definition or a normal behavior profile associated with the IoT device, the notification or the event identifying the IoT device and a type of event.

27. The system as defined in claim 21, wherein the enforcement rule defines at least one of an application or an endpoint to be allowed or blocked for the IoT device or group of IoT devices.

28. The system as defined in claim 27, wherein the rule enforcement system is configured to control the data traffic based on the enforcement rule by controlling the packet core network to at least one of block or allow a data packet or a DNS request.

29. (canceled)

30. The system as defined in claim 21, wherein the packet core network is configured to assign IP addresses to the IoT devices using dynamic assignment.

31. The system as defined in claim 21, wherein the packet core network is configured to collect the data traffic by capturing and storing one or more of a source IP address associated with the data traffic, a destination IP address associated with the data traffic, a network protocol associated with the data traffic, a source port associated with the data traffic, a destination port associated with the data traffic, or a payload size associated with the data traffic.

32. The system as defined in claim 21, wherein the enforcement rules comprise at least one of blocking the data traffic, suspending the IoT device, or disconnecting the IoT device.

33. The system as defined in claim 21, wherein at least one of the defining or the assigning of the enforcement rules is based on input from the user.

34. The system as defined in claim 21, wherein the packet core network comprises a mobile network operator or a mobile virtual network operator.

35. The system as defined in claim 21, further comprising a traffic awareness system configured to present information representative of anomalous and normal data traffic for the IoT device or the group of IoT devices to the user.

36. The system as defined in claim 21, wherein the information representative of anomalous and normal data traffic includes presenting a source IP address associated with the data traffic, a destination IP address associated with the data traffic, a network protocol associated with the data traffic, a source port associated with the data traffic, a destination port associated with the data traffic, or a payload size associated with the data traffic.

37. The system as defined in claim 21, wherein the traffic evaluation system is configured to generate anomalous event definitions for individual ones of the IoT devices, the anomalous event definitions being generated for ones of the IoT devices based on the data traffic.

38. The system as defined in claim 37, wherein the traffic evaluation system is configured to generate the anomalous event definitions by analyzing the data traffic using at least one of a machine learning model or heuristics.

39. The system as defined in claim 38, wherein the traffic evaluation system is configured to train the machine learning model on historical data traffic for the IoT device stored in a data repository.

40. The system as defined in claim 21, wherein the rule enforcement system is configured to assign the enforcement rules to one or more of the IoT devices or the group of IoT devices by associating one or more of the IoT devices with a traffic policy based on at least one of the unique identifier of the one or more of the IoT devices, an APN of the one or more of the IoT devices, a TAC code of the one or more of the IoT devices, or a custom label applied to the one or more of the IoT devices.

41-71. (canceled)
